(19) United States
(12) Patent Application Publication
(10) Pub. No.: US 2005/0093294 A1
(43) Pub. Date: May 5, 2005

(54) Flexible hose assembly for fuel cell applications

(76) Inventors: Scott G. Anselmo, Cromwell, CT (US); Douglas R. Ausdemore, Manchester, CT (US)

Correspondence Address: Christopher H. Hunter;PARKER-HANNIFIN CORPORATION, 6035 Parkland Boulevard, Cleveland, OH, 44124-4141, US

(21) Appl. No.: 10/931,666

(22) Filed: Sep. 1, 2004

Related U.S. Application Data
(60) Provisional application No. 60/518,609, filed on Oct. 31, 2003.

(51) Int. Cl. F16L 33/00

(52) U.S. Cl. 285/247; 285/245; 285/903

(57) ABSTRACT

A fluid tight connection, including a hose assembly, a component to be connected such as an adapter, and an O-ring seal between the hose assembly and adapter. The hose assembly includes a length of metal tube with a central, corrugated portion providing flexibility for the tube, and smooth portions adjacent one or both ends. An annular sleeve is located on one or both tube ends, and brazed to the smooth surface portion. A nut is loosely received about the tube, and has an internal cavity with threaded forward portion enabling the nut to be screwed onto the adapter, and a rear portion with an inner annular shoulder having an inner diameter smaller than the outer diameter of the sleeve which prevents the nut from being removed over the sleeve. The O-ring seal is located between a forward end of the sleeve and an inner annular shoulder of the adapter.

### CROSS-REFERENCE TO RELATED CASES

The present application claims the benefit of the filing date of U.S. Provisional Application Ser. No. 60/518,609; filed Oct. 31, 2003, the disclosure of which is expressly incorporated herein by reference.

### FIELD OF THE INVENTION

The present invention relates generally to hose assemblies for fuel cell applications.

### BACKGROUND OF THE INVENTION

Hose assemblies are well-known in the process industry to fluidly connect different apparatus. Certain of the tubes for such assemblies are formed from metal when the application so requires. For robust applications, many of such tubes are generally inflexible, that is, they have a substantial wall thickness, or are formed of a material, that makes them relatively rigid.

One useful and well-known connection for such a tube which enables the tube to be relatively easily connected to another hose assembly or directly to a component or device, includes a metal annular sleeve that is closely received over the end of the tube, and the use of a tool which is pressed against the end of the tube to deform the tube end into a die, as shown in U.S. Pat. No. 5,131,145. In such case, the tube end takes on the form of the die, and has a dimension to prevent the sleeve from being removed from the end of the tube. A nut with a threaded portion is also initially received over the tube end before forming, and has an internal dimension (inner annular shoulder) smaller than the sleeve, such that the nut is also retained on the tube after the forming process. The nut surrounds the sleeve and tube end, and has a forward end that can be threaded down onto an adjacent component or device, such as a threaded adapter or fitting, with the nut forcing the sleeve forwardly against the deformed end of the tube to make a fluid-tight connection. The connection is typically a metal-to-metal seal, although it is also known to provide an elastomeric O-ring seal between the formed end of the tube and the adjacent apparatus to further prevent fluid leakage.

Such a connection as described above provides many advantages, and has received widespread acceptance in many markets, but is generally limited to situations where the hose assembly is stationary and fixed. That is, the connection is generally not suggested for situations where the devices and components are movable relative to each other, as the movement can cause the sleeve to cock on the end of the tube and/or the nut to cock on the sleeve, and create a leak path. In addition, it is generally not used when the devices and components to be connected are not directly opposite one another (are off-centered), as the sleeve and nut can become cocked if it is attempted to bend the hose assembly during the connection process, or it can be difficult or virtually impossible to thread the nut down on the adjacent fitting. It is applicant's experience that the above situations are frequently prevalent in the connection process between various components and devices in fuel cell assemblies. Of course, a bent tube can be provided to satisfy the situation where the connection points are not directly opposite one another, but this requires manufacturing steps to form the tube, is time-consuming, and requires various stock keeping units, which over-all is undesirable in many situations.

It is therefore believed there is a demand in the industry, and in particular the fuel cell industry, for a hose assembly that provides a leak-free connection between devices and components, and is particularly useful when the devices and components are moveable relative to each other, and/or when the connection points are not directly opposite one another.

### SUMMARY OF THE INVENTION

The present invention thereby provides a hose assembly that provides a leak free connection, and is useful when the devices and components are moveable relative to each other, and/or when the connection points are not directly opposite one another.

According to the invention, the hose assembly includes a flexible tube, such as a convoluted tube; an annular sleeve; and a nut. The convoluted tube includes a smooth section adjacent one (or both) ends, and the sleeve is closely received on the smooth end section. The sleeve is brazed or otherwise permanently fixed onto the tube, and no other forming of the tube is necessary. The nut is preassembled on the tube, and is retained on the tube end by the fixed sleeve, as in the known manner. The nut surrounds the sleeve, and has a threaded forward portion that enables the nut to be threaded down onto an adjacent fitting to fluidly connect the hose assembly to a component or device.

A hose assembly assembled and constructed in the above manner provides flexibility in attaching off-centered connection points in a leak-free manner by allowing the tube to be easily bent without causing the nut to cock. It is therefore easier to screw the nut down onto the adjacent fitting. The fixed connection of the sleeve to the tube also eliminates a potential leak path. The components and devices can also have limited movement that is absorbed by the flexible tube without causing movement of the nut relative to the sleeve. An O-ring seal can be located between the forward end of the sleeve and the adjacent fitting, to further facilitate the leak-free seal.

The tube can also be formed of relatively thinner, less expensive material, which makes the assembly lighter and can reduce the overall cost of the assembly.

As such, the present invention thereby provides a hose assembly that provides a leak free connection, and is useful when the devices and components are moveable relative to each other, and/or when the connection points are not directly opposite one another. The hose assembly is particularly appropriate for the fuel cell industry.

Other features and advantages of the present invention will become further apparent upon reviewing the following specification and attached drawings.

### BRIEF DESCRIPTION OF THE DRAWINGS

FIG. 1 is a cross-sectional side view of a portion of a fluid connection constructed according to the present invention;

FIG. 2 is an exploded view of the fluid connection of FIG. 1; and

FIG. 3 is a cross-sectional exploded view of the fluid connection of FIG. 1.

### DETAILED DESCRIPTION OF THE PREFERRED EMBODIMENT

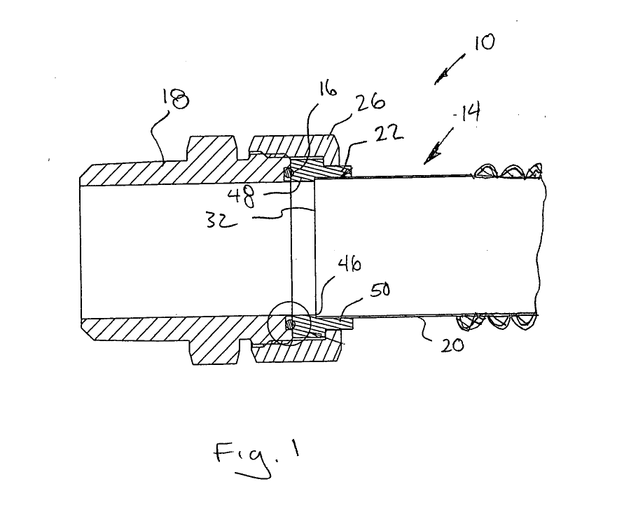

Referring to the drawings, and initially to FIG. 1, a fluid connection constructed according to the present invention is indicated generally at 10. The hose connection 10 includes a hose assembly, indicated generally at 14; an O-ring seal 16, and a component or device to be connected, e.g., an adapter 18.

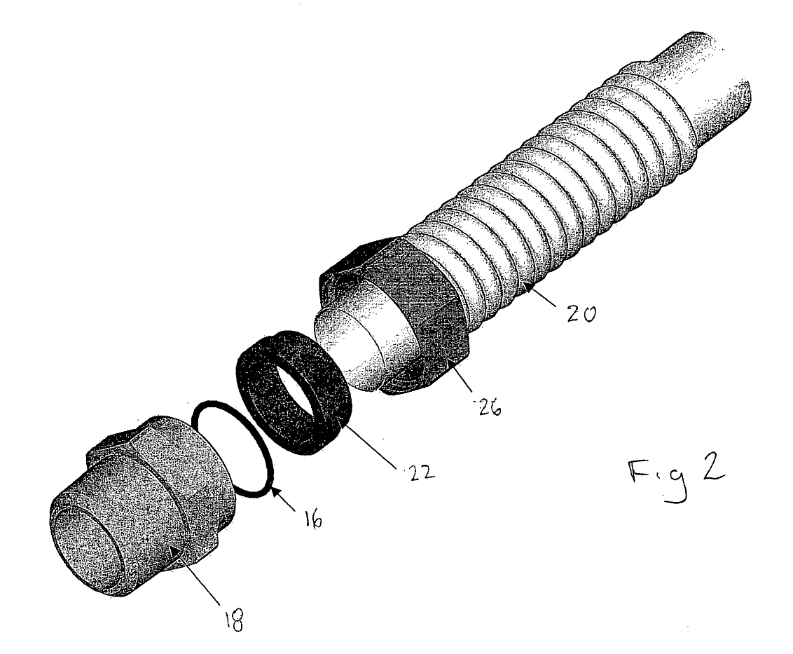

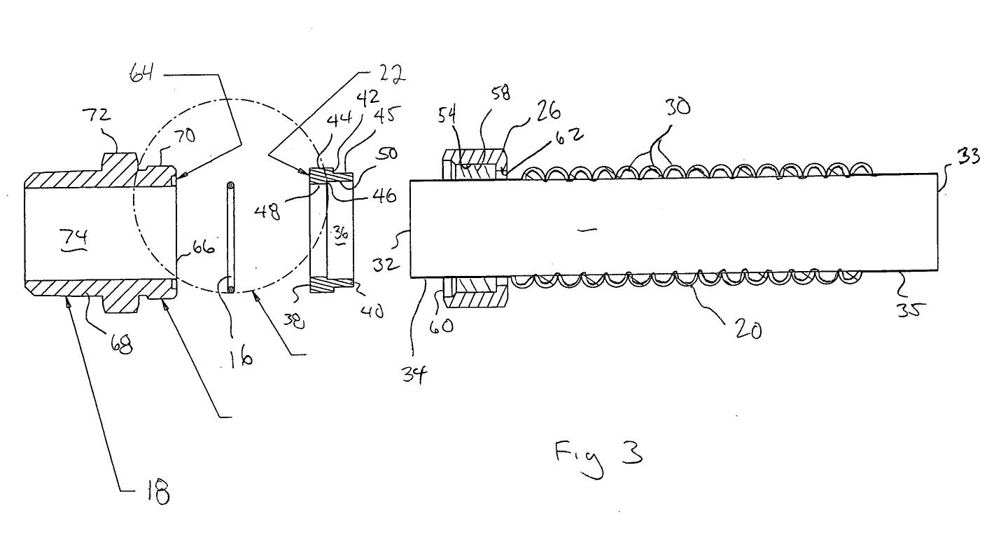

As also shown in FIGS. 2 and 3, the hose assembly 14 includes a tube 20, a sleeve 22 and a nut 26. The tube 20 can be formed of a material appropriate for the particular application. In a fuel cell application, one use for the hose assembly would be to connect components and devices for the transfer of hydrogen. As such, the tube would typically be formed of a corrosion resistant material capable of handling this gas, such as type 316 or 316L Stainless Steel. A preferred wall thickness for a tube used in this application would be in the range of 0.010 inches, and the diameter would generally be dictated by the desired volume of fluid (½ inch, ¾ inch. 1 inch, etc.). The length of the tube can vary depending on the particular application. Internal dimensions could also vary depending on the volume of fluid to be transported.

According to the present invention, tube 20 has substantial flexibility, that is, it has substantially more flexibility than is normally found with rigid tubes typically used for such applications. Preferably the sidewall of the tube is formed to have a corrugated geometry to enable the tube to be bent into useful configurations. More preferably a series of folds as at 30 are formed along the length of the tube, starting at a location spaced from each end 32, 33 of the tube. The tube has end portions 34, 35, between the corrugated geometry and the ends 32, 33 of the tube, which are generally smooth and continuous. The end portions 32, 33 have such a geometry to facilitate locating sleeves 22 on either (or both) ends of the tube. It is noted that only one end of the hose might have a fluid connection as described herein, and as such, only one end would have such a smooth portion. The other end might be connected integrally and directly to a device or component, or have some other form of connection, and thereby have a different geometry.

In any case, the sleeve 22 is likewise formed of an appropriate material, for example 316L stainless steel, and has a generally annular shape with an internal bore 36 with a diameter allowing the sleeve to be closely received about either end 32, 33 of the tube and located on the smooth portion 34, 35. The sleeve 22 has a flat annular front surface 38, a flat annular rear surface 40; and a rearwardly-facing flat external annular shoulder 42 formed about the midpoint of the sleeve, and defining a forward portion 44 with a larger external diameter; and a rear portion 45 with a smaller external diameter. A rearwardly-facing internal annular shoulder 46 is also provided in the sleeve and defines a forward portion 48 with a smaller internal diameter; and a rear portion 50 with a larger internal diameter. The rear portion 50 has the dimension allowing the sleeve to be slid onto the end of the tube, while the forward portion 48 has a dimension slightly smaller than the dimension of the tube.

As illustrated in FIG. 1, the tube end 32 is inserted into and closely received by the rear portion 50 of the sleeve, and abuts the shoulder 46, which forms a stop surface to accurately locate the sleeve and tube relative to each other. The forward end 48 of the sleeve extends forwardly of the tube end 32, and has an inner diameter approximately the same as the inner diameter of the tube such that a substantially flush internal surface is presented to the fluid flowing through the tube.

The sleeve is preferably permanently mechanically fixed to the tube, such as by brazing, although other techniques, such as welding, are also possible. The brazing process is preferably conventional in nature. A brazing paste is applied to the outer surface of the tube in the area of the appropriate end portion 32, 34, and the sleeve is then located in the appropriate location, and the assembly is then put into a brazing furnace for an appropriate length of time, cooled, and then pressure tested.

The nut 26 is preferably also formed of a material appropriate and complementary to the hose and sleeve material, for example 316L Stainless Steel, and has an exterior hexagonal shape to facilitate easy engagement by an appropriate tool. The nut further has an internal annular chamber 54 that is partially or entirely threaded as at 58; and has an entrance opening 60 at a forward end, and a radially inward projecting annular shoulder 62 at a rear end. Shoulder 62 has an internal diameter larger than the outer diameter of the rear portion 45 of the sleeve so that the flange is received over the rear portion; but smaller than the outer diameter of the forward portion 44, to prevent the nut from being removed entirely over the sleeve. The shoulder 62 on the nut abuts the shoulder 42 on the sleeve when the nut is located over the sleeve. The nut 26 receives the sleeve 22 through the entrance opening 60, and preferably projects forward of the sleeve and tube end (see e.g., FIG. 1).

The O-ring 16 is preferably a conventional elastomeric O-ring having an annular configuration, and sized so as to lay flat against the forward face 38 of the sleeve 22. In appropriate circumstances, such as in high-temperature applications, the O-ring can be a metal O-ring. The O-ring can be received in a dove tail or square cut channel formed on the front surface 38 of the sleeve; or as illustrated, can be received in such a channel 64 formed in the forward annular flat end 66 of the adapter 18 (or other appropriate adjacent fitting), and projects slightly outward therefrom. A metal O-ring could also be used in higher-temperature situations.

The adapter 18 is illustrated as having a cylindrical body 68 with a forward exterior threaded portion 70 adapted to be threadably received in the cavity 58 of nut 26. The rear exterior portion 71 of the adapter can also be threaded and received in an apparatus, or within a further hose assembly. An external geometry, such as a hex geometry 72 can be provided on the adapter to facilitate connecting the adapter and the hose assembly. The internal bore 74 of the adapter has substantially the same internal diameter as tube 14 and sleeve 16. The adapter is also preferably formed of a material complementary and appropriate with the hose assembly, such as 316L Stainless Steel. Again, the hose assembly 14 can be fixed to connecting members other than adapter 18, such as directly to a machine.

When the nut is threaded down onto the adapter 18, the nut forces the forward surface of the sleeve against the end of the adapter, to create a fluid-tight seal.

The connection described above is particularly useful to fluidly connect apparatus used in the fuel cell industry, such as heat exchangers, conditioners, desulferizers, etc., however it is believed this is only a partial list, and that the present invention is useful in a broad range of potential applications and fluids.

The connection described above is leak-free, strong, and corrosion resistant. For the same application, it is believed the tubes can have walls that can be over 60% thinner, which as should be appreciated, results in a lighter hose assembly and a reduced material cost. Burst pressures and working temperature can be as good if not better than hose assemblies with rigid tube.

As described above, the present invention thereby provides a hose assembly that provides a leak free connection, and is useful in situations where the hose assemblies with rigid tubes have certain disadvantages, such as when the devices and components to be connected are moveable relative to each other, and/or when the connection points are not directly opposite one another. The hose assembly is particularly appropriate for the fuel cell industry.

The principles, preferred embodiments and modes of operation of the present invention have been described in the foregoing specification. The invention which is intended to be protected herein should not, however, be construed as limited to the particular form described as it is to be regarded as illustrative rather than restrictive. Variations and changes may be made by those skilled in the art without departing from the scope and spirit of the invention as set forth in the appended claims.

1. A hose assembly, comprising:
a length of metal tube, said tube having first and second ends, with a smooth exterior uninterrupted surface portion adjacent at least one end, said tube having a geometry between said ends which enables said tube to easily flex;
an annular sleeve closely received over said tube, and permanently mechanically bonded to the smooth surface portion;
a nut generally loosely received around the tube, said nut having a threaded forward portion enabling the nut to be screwed onto a cooperating fitting, and an internal cavity with rear portion with an inner annular shoulder having an inner dimension smaller than the outer dimension of the sleeve which prevents the nut from being removed over the sleeve.

2. The flexible hose assembly as in claim 1, wherein said tube has a central corrugated portion between said ends.

3. The flexible hose assembly as in claim 2, wherein the tube has smooth exterior uninterrupted surface portion adjacent each end.

4. The flexible hose assembly as in claim 2, wherein said tube has a relatively thin sidewall, and the corrugated portion of the tube includes a series of folds, providing flexibility for the tube.

5. The flexible hose assembly as in claim 1, further including a braze joint between the sleeve and the tube.

6. The flexible hose assembly as in claim 1, wherein the sleeve includes an inner stepped surface, with a forward, reduced diameter portion of the sleeve having a dimension smaller than an outer dimension of the tube; and a rear, enlarged diameter portion of the sleeve having a dimension larger than the outer diameter of the tube, such that one end of the tube is closely received in the rear portion, and abuts a shoulder intermediate the smaller and larger portions, and the smaller portion of the sleeve projects forwardly of the one tube end.

7. A fluid tight connection, comprising:
a hose assembly, a threaded adapter and an elastomeric O-ring seal located between the hose assembly and the adapter, the hose assembly including a length of metal tube, said tube having first and second ends, with a smooth exterior uninterrupted surface portion adjacent each end, said tube having a central corrugated portion between said ends which enables said tube to easily flex;
an annular sleeve generally closely received over said tube at one end, and permanently mechanically brazed to the smooth surface portion of the tube;
a nut generally loosely received around the tube, said nut having an internal cavity with threaded forward portion enabling the nut to be screwed onto the adapter, and a rear portion with an inner annular shoulder having an inner diameter smaller than the outer diameter of the sleeve which prevents the nut from being removed over the sleeve;
the O-ring seal located against a forward end of the sleeve and between the sleeve and an inner annular shoulder of the adapter, the adapter including a body with a circular central cavity having an internal dimension about the same as that of the tube.

8. The flexible hose assembly as in claim 7, wherein said tube has a relatively thin sidewall, and the corrugated portion of the tube includes a series of folds, providing flexibility for the tube.

9. The flexible hose assembly as in claim 7, wherein the sleeve includes an inner stepped surface, with a forward, reduced diameter portion of the sleeve having a dimension smaller than an outer dimension of the tube; and a rear, enlarged diameter portion of the sleeve having a dimension larger than the outer diameter of the tube, such that one end of the tube is closely received in the rear portion, and abuts a shoulder intermediate the smaller and larger portions, and the smaller portion of the sleeve projects forwardly of the one tube end.
